(19) United States
(12) Patent Application Publication
(10) Pub. No.: US 2021/0122631 A1
(43) Pub. Date: Apr. 29, 2021

(54) Method and Systems for Treating Synthesis Gas

(71) Applicant: MILENA-OLGA Joint Innovation Assets B.V., Maassluis (NL)

(72) Inventors: Robin Willem Rudolf Zwart, Maassluis (NL); Simon Pieter Van Der Heijden, Maassluis (NL); Martines Teodoor Van 'T Hoff, Maassluis (NL); Petrus Jacobus Adrianus Tijm, Maassluis (NL)

(21) Appl. No.: 17/142,580

(22) Filed: Jan. 6, 2021

Related U.S. Application Data
(63) Continuation of application No. 15/573,700, filed on Nov. 13, 2017, now abandoned.

(30) Foreign Application Priority Data
May 11, 2015 (NL) 2014786

(51) Int. Cl. C01B 3/34; C10K 1/04; C10J 3/84; C10J 3/86; C10K 1/00; F01D 1/00; F02C 6/18

(52) U.S. Cl. CPC C01B 3/34; C10K 1/046; C10J 3/84; C10J 3/86; C10K 1/004; C01B 2203/0883; F02C 6/18; C10J 2300/1884; Y02E 20/18; Y02P 20/129; F01D 1/00

(57) ABSTRACT

The present invention relates to a method for treating synthesis gas, from an indirect or direct gasifier; the method including steps for: allowing the gas within a predetermined entry temperature range to flow into a first heat exchanger, allowing the gas to flow through the first heat exchanger while exchanging heat to a first medium, allowing the gas to transfer from the first heat exchanger to a subsequent last heat exchanger, allowing the gas to flow though the last heat exchanger while exchanging heat to a last medium, and allowing the gas to exit the last heat exchanger for being available to a further treatment, such as a cleaning treatment, within a predetermined exit temperature range, preferably below an ash or mineral solidification point. Furthermore, the present invention relates to a cooling system for cooling of synthesis gas and to a gasification system.

### CROSS REFERENCE TO RELATED APPLICATIONS

This application is a continuation of U.S. application Ser. No. 15/573,700 filed Nov. 13, 2017 which is the United States national phase of International Application No. PCT/NL2016/050335 filed May 11, 2016, and claims priority to Dutch Patent Application No. 2014786 filed May 11, 2015, the disclosures of which are hereby incorporated in their entirety by reference.

### BACKGROUND OF THE INVENTION

### Field of the Invention

The present invention relates to a method for treating synthesis gas, such as gasification gas, such as between initial production and cleaning thereof, from an indirect or direct gasifier. A further aspect of the present invention relates to a cooling system for synthesis gas, such as gasification gas, such as between initial production and cleaning thereof, from an indirect or direct gasifier. A further aspect of the present invention relates to a gasification system for producing synthesis gas comprising a cooling system according to the present invention.

Cooling of synthesis gas has been facing serious problems. Such problems include particulate build up in coolers, either by a temperature of the wall of the cooler that is too low or too unpredictable. Particles, such as fly slag, lead to erosion. A known protection against such erosion is ceramic protection shields, the cost of which is prohibitive. Another problem is condensation. When condensation occurs, cumbersome emulsions in the cooler arise.

### SUMMARY OF THE INVENTION

In order to improve upon such systems with the known problems, the present invention provides a method for treating synthesis gas, such as gasification gas, such as between initial production and cleaning thereof, from an indirect or direct gasifier; the method comprising steps for:
allowing the gas within a predetermined entry temperature range to flow into a first heat exchanger,
allowing the gas to flow through the first heat exchanger while exchanging heat to a first medium, preferably a steam medium,
allowing the gas to transfer from the first heat exchanger to a subsequent last heat exchanger,
allowing the gas to flow though the last heat exchanger while exchanging heat to a last medium, preferably also a steam medium,
allowing the gas to exit the last heat exchanger for being available to a further treatment, such as a cleaning treatment, within a predetermined exit temperature range, preferably below an ash or mineral solidification point and preferably above a hydrocarbon liquefying point.

A device according to this present invention provides the advantage cooling may be performed with limited or substantially nonexistent condensation of tars or deposition of solids. Metal parts of the cooler may be kept at the temperature of the medium, such as steam, preventing such condensation of tars or deposition of solids. Because 2, or preferably more, heat exchangers are applied, a gradual cooling can be achieved. The temperature differences of the gas as well as the medium can be predictably kept within ranges that prevent such condensation of tars or deposition of solids.

In the methods according to a first preferred embodiment, the heat exchangers operate on steam cooling, preferably fully operate on, preferably steam cooling. This is possible because of the predetermined entry temperature range and predetermined exit temperature range. Preferably, the heat exchangers operate on superheated steam cooling, preferably fully operate on superheated steam cooling.

According to a further preferred embodiment, the heat medium is obtained from, or pre heated in, a flue gas cooler of the gasifier and/or in a heat recovery step relating to the synthesis gas passing through the first or subsequent heat exchanger. Because of this, at least after initial startup of the system, the temperatures of the medium are predictably controllable such that the said disadvantages can be further reduced. Another important advantage of this feature is that heat energy from the gas or from a gas conversion process, can be used to create the steam required in the heat exchangers. Furthermore, it is provided that excess energy is led to a steam turbine.

Preferably, the entry temperature range is between 600-1200° C., preferably between 650-1000° C., further preferably between 700-900° C., further preferably between 750-850° C. Preferably, the exit temperature range is between 400-600° C., preferably between 450-550° C., preferably substantially around 500° C. These temperature ranges provides an optimal residence time of the synthetic gas in the system. Especially, the residence time during the subsequent cooling step is hereby optimized.

A method according to a further preferred embodiment comprises steps of reusing the first medium as the last medium. A large advantage thereof is that both the location of the medium is suitable for use in the 2nd heat exchanger and that the temperature of the medium can be easily adjusted, which has become required as synthesis gas has past heat into the medium.

Such adjustment is preferably performed by adding a coolant, such as water, before entering the last heat exchanger, this step of adjusting preferably being performed by means of an attemperator. By varying the water input into the medium, the temperature can be lowered depending on the passing synthesis gas. Because the medium or the water does not come into direct contact with the synthesis gas, a very controlled cooling preventing the said disadvantages of the prior art, such as direct insertion of water into the synthesis gas leading to condensation or particulate build up.

In a further preferred embodiment, it is provided to apply at least one intermediate heat exchanger with at least one perspective intermediate medium, such as 1, 2, 3 or more intermediate heat exchangers. An advantage thereof comprises that a larger temperature difference can be obtained or that a higher speed of operation can be achieved.

Preferably, any of the heat exchangers is of the fire tube type, or further preferably, any of the heat exchangers is of the water tube type.

According to a further preferred embodiment, the method comprises steps for cleaning the synthesis gas by removing particulates, tars, acid gases such as sulfur or chlorine compounds, and water, preferably in that order, preferably in a synthesis gas cleanup reactor. The present invention provides the advantage that the residence time of the synthesis gas in such a cleanup reactor can be minimized. A further advantage is that such cleaned gas can be reliably used in a turbine or a gas conversion process.

Further preferably, a method comprises steps for feeding the synthesis gas into a gas turbine for driving a generator set, preferably to generate primary power. This provides the advantage that energy present in the synthesis gas then be used for transitions such as generating electricity.

The method comprises in a further embodiment steps for operating a steam turbine of energy remaining in the medium from the last heat exchanger and or from energy remaining from a medium from the heat recovery step. Excess energy, that is not used in the heat exchangers or for example a turbine, is intended to be used for transitioning such heat energy into electricity.

Adjusting the entrance temperature of the last medium, preferably by adding water to the last medium after exiting last heat exchanger is a solution according to a further preferred embodiment. This helps in providing just enough lowering of the temperature to provide cooling, yet to prevent condensation or particulate build up.

A further aspect according to the present invention provides a cooling system for cooling synthesis gas, such as gasification gas, such as between initial production and cleaning thereof, from an indirect or direct gasifier; the method comprising steps for:
a first heat exchanger for allowing the gas to exchange heat to a first medium, preferably a steam medium,
a subsequent last heat exchanger for allowing the gas to exchange heat to last medium, preferably a superheated steam medium,
include means for allowing the gas to enter the 1st heat exchanger, preferably from initial production means and or initial cooling means,
exit means for allowing the gas to exit the last heat exchanger, preferably for being available to a further treatment, such as a cleaning treatment, within an exit temperature range, preferably below an ash or mineral solidification point and preferably above a hydrocarbon liquefying point. Such a cooling system provides similar advantages as described in the above relating to the method for treating synthesis gas.

According to a preferred embodiment, in such a cooling system, the exchangers are operable on steam cooling, preferably fully operable on, further preferably superheated, steam cooling. Further preferably, the system comprises means for adjusting the entrance temperature of the last medium, preferably by adding water to the last medium after exiting last heat exchanger. Also such embodiments provide similar advantages as describes relating to the above methods.

A further aspect according to the present invention provides a gasification system for production of synthesis gas comprising a cooling system according to embodiments according to the present invention, further comprising:
a gasifier, preferably a gasifier with a gasification reactor, a heat generator and a separation cyclone for separating bed material from a raw synthesis gas,
a flue gas cooler comprising means for heating up steam for use in the heat exchangers,
a cleaning system for cleaning synthesis gas after leaving the last heat exchanger by removing particulates, tars, acid gases such as sulfur or chlorine compounds, and water, preferably in that order,
a gas turbine for driving a generator set, preferably to generate primary power,
a heat recovery device, such as a heat recovery steam generator, HRSG, relating to the synthesis gas passing through the first or subsequent heat exchanger, and/or
a steam turbine of energy remaining in the medium from the last heat exchanger and or from energy remaining from a medium from the heat recovery step.

Advantages have been described in the above relating to individual features as described according to this aspect.

### BRIEF DESCRIPTION OF THE DRAWING(S)

Further advantages, features and details of the present invention will be further elucidated on the basis of a description of one or more embodiments with reference to the accompanying figures.

FIG. 1 shows a schematic representation of a 1st preferred embodiment according to the present invention.

FIG. 2 shows a schematic representation of additional elements of the 1st preferred embodiment.

FIG. 3 shows a schematic representation of a 2nd preferred embodiment according to the present invention.

FIG. 4 shows a schematic representation of additional elements of the 2nd preferred embodiment.

FIG. 5 shows a schematic representation of a 3rd preferred embodiment according to the present invention.

### DETAILED DESCRIPTION OF THE INVENTION

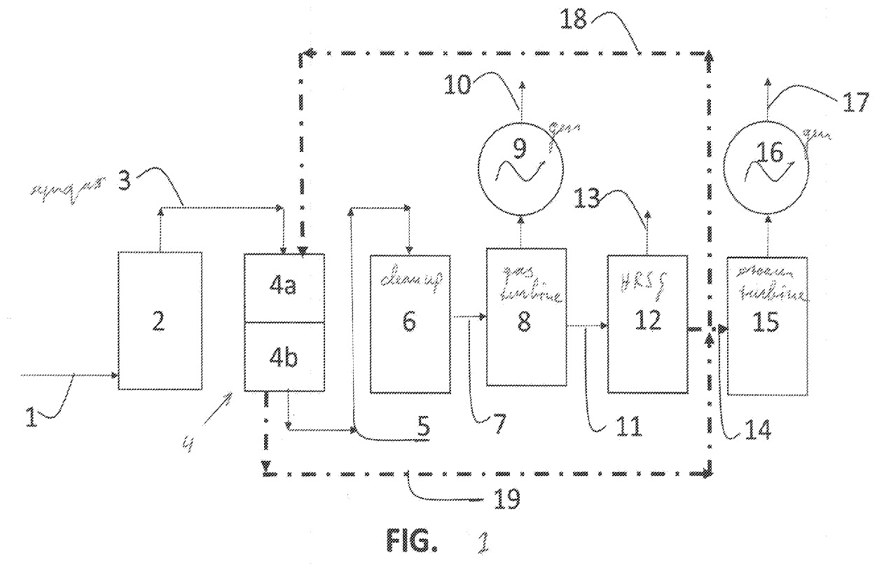

FIG. 1 shows a first preferred embodiment according to the present invention. This 1st preferred embodiment is a so-called integrated gasification combined cycle IGCC system equipped with a direct gasifier, incorporating a heat exchanger 4 according to a preferred embodiment of the present invention structurally included into the gasifier system according to a preferred embodiment of the present invention.

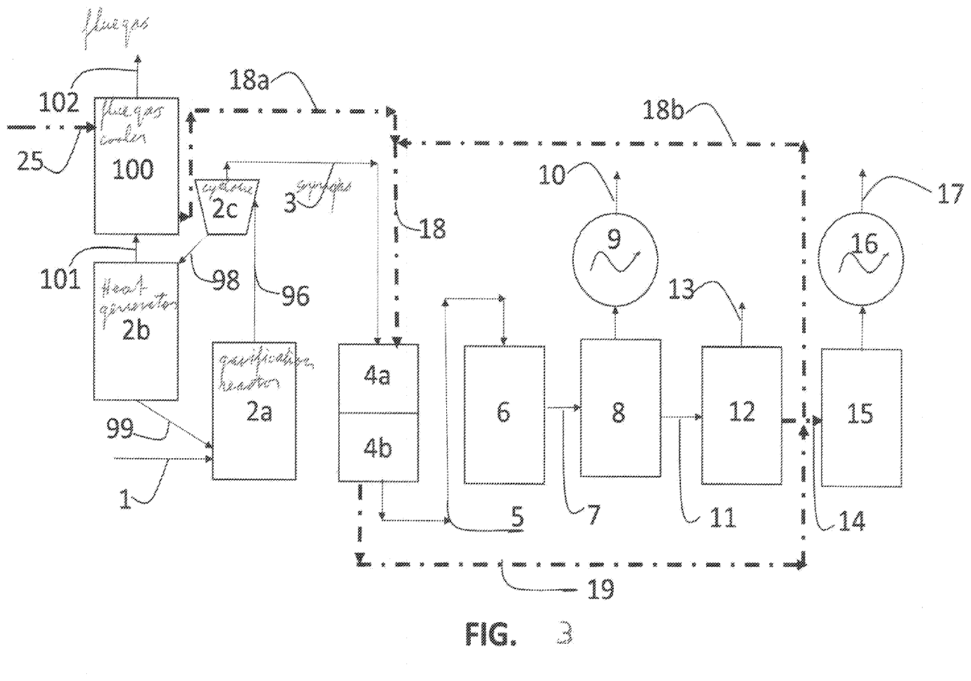

The heat exchanger runs on a cooling medium provided by other elements of system, at a temperature based on energy provided by other elements of the system. The exchangers of other preferred embodiments (FIGS. 3-5) also are provided with a cooling medium provided by other elements of system, at a temperature based on energy provided by other elements of the system.

According to embodiments, hydrocarbon feedstock (coal, petroleum coke, heavy fuel oil, biomass, wood-based materials, agricultural waste, tars, coke oven gas, asphalt or natural gas), and an oxidizer (air, enriched air, oxygen and/or steam) 1 are fed to a direct gasifier 2 to produce a raw synthesis gas 3. The raw synthesis gas 3 is preferably maintained, irrespective of the type of gasifier or process used, to be at about 700-900° C. or to be quenched to this temperature before entering the heat exchangers 4a,4b.

For example the synthesis gas 3 may be generated by a coke oven or steel mill and already be at the 700-900° C. For reasons described above the hot synthesis gas is cooled further in the heat exchangers. Therefore this synthesis gas is subsequently cooled in synthesis gas coolers 4a and 4b.

The synthesis gas 5 exiting the cooler, cooled to below 500° C., is then ready for the synthesis gas clean-up 6. As is apparent from FIG. 1, all of the raw synthetic gas travels through the heat exchangers 4a, 4b and then to the synthetic gas clean-up 6. This clean-up has the objective to remove, preferably first, any remaining particulates, then tars, acid gases and, preferably finally, water. The cleaned synthesis gas, after the gas cleanup almost free of contamination and on gas turbine feed gas specification 7, is then fed to the gas turbine 8, which drives a generator set 9 to generate the primary power 10.

The hot exhaust gases from the combustion chamber of the gas turbine 11 are led to a heat recovery steam generator (HRSG) 12, which purpose is to recover the sensible heat and generate, preferably superheated, steam 14. The cooled exhaust gases 13 go to the system's stack. The steam 14 serves two purposes: the high quality superheated steam 18 is routed to the synthesis gas coolers 4a and 4b to flow co-currently with the hot raw quality synthesis gas 3 and provide controlled cooling of the metal heat exchange surfaces of the cooler.

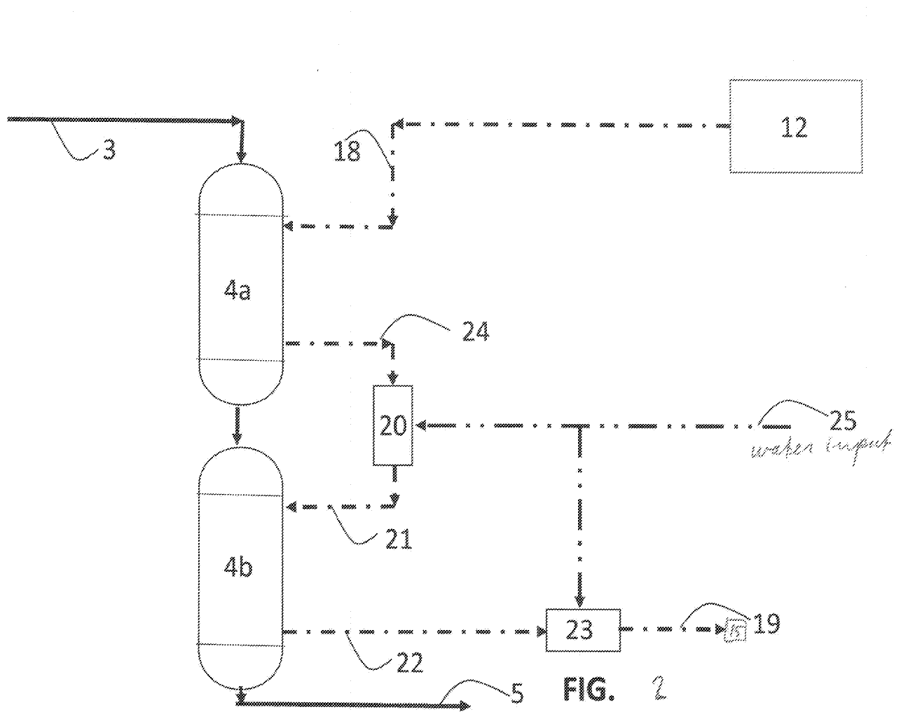

It shall be clear to those skilled in the art that, depending on the size of the IGCC this can happen in one, with one single heat exchanger 4, or several stages of which two are depicted. The high quality steam becomes even further superheated in this process. In order to control the temperature and quality of this steam it is led to an attemperator (refer to details in FIG. 2) to become larger in volume. Subsequently this steam is fed back to the inlet of the steam turbine 15, which drives a second generator 16 to generate additional power 17.

FIG. 2 discloses a gasifier 2, for producing a raw quality synthesis gas 3, which, irrespective of the type of gasifier used, whether direct or indirect, in this process description is preferably quenched to or be at about 700-900° C. When adding more heat exchangers those values may vary.

This synthesis gas is subsequently cooled in synthesis gas cooler 4. The synthesis gas 5 exiting the cooler, is preferably cooled to an exiting gas temperature of below 500° C. For this purpose the raw quality synthesis gas 3 enters the top synthesis gas cooler 4a, the first in the series of two, or one or more. The steam flow 18 from the HRSG 12 enters the cooler in co-current flow with the synthesis gas. Having the preferred low steam temperature at this point, this provides for the preferred heat removal capacity at the point of a preferred high heat flux, i.e. the synthesis gas cooler inlet.

Also this operation is instrumental that the preferred lowest temperature, of any spot on the metal surface of the synthesis gas cooler, is the temperature of the inlet steam 18. The latter is controlled by the operating pressure of the HRSG system. At the outlet of synthesis gas cooler 4a the steam 24 is superheated and needs to be corrected in temperature.

This is performed in the attemperator 20. In this device the steam exiting the first synthesis gas cooler 4a is intimately mixed with cooler feed water 25 to produce a larger volume (more) saturated steam 21, which subsequently is the feed and cooling medium for the second synthesis gas cooler 4b. In this synthesis gas cooling the process regarding the first synthesis gas cooler 4a is repetitive.

Raw quality synthesis gas exiting the synthesis gas cooler 4a enters synthesis gas cooler 4b, the second in the series of two. Steam flow 21 enters the cooler in co-current flow with the synthesis gas. Having a low steam temperature at this point, this provides a preferred heat removal capacity at the point of the preferred heat flux, i.e. the synthesis gas cooler inlet. This operation is instrumental that the lowest temperature of any spot on the metal surface of the synthesis gas cooler 4b, is the temperature of the inlet steam 21.

The latter is controlled by the operation of the attemperator 20. At the outlet of synthesis gas cooler 4b the steam is again superheated and is corrected in temperature for use in the steam turbine 15. This is achieved in attemperator 23. In this device the steam exiting the second synthesis gas cooler 4b is intimately mixed with cooler feed water 25 to produce a larger volume (more) saturated steam 19. The synthesis gas 5, exiting synthesis gas cooler 4b, reaches the desired temperature of below 500° C., though is at a temperature well above the dew point of preferred tars and well above the temperature of deposition of e.g. ammonium chlorides.

In the embodiment of FIG. 3 hydrocarbon feedstock (coal, petroleum coke, heavy fuel oil, biomass, wood-based materials, agricultural waste, tars, coke oven gas, asphalt or natural gas), and an oxidizer (air, enriched air, oxygen and/or steam) 1 is fed to the gasification reactor 2a of an indirect gasifier 2a+2b. In the bottom of this reactor it is mixed with hot bed material 99 from heat generator 2b.

After gasification a mixture of raw synthesis gas and bed material 96 leaves the gasifier reactor 2a and enters cyclone 2c to be separated in a char laden bed material 98 and a raw synthesis gas 3. The char laden bed material 98 is routed to the indirect gasifier heat generator 2b, where the char is combusted to generate hot bed material 99.

The flue gas 101 from the heat generator is routed to evaporative flue gas cooler 100 to yield cooled (about 200° C.) flue gas 102 and, from boiler feed water 25 it preferably yields saturated steam 18a. The raw synthesis gas 3 needs, irrespective of the type of gasifier or process used, to be at about 700° C.-900° C. or to be quenched to this temperature. For example the synthesis gas 3 may be generated by a coke oven or steel mill and already be at the 700° C.-900° C. For reasons explained in the above, the hot synthesis gas is cooled further. Therefore this synthesis gas is subsequently cooled in synthesis gas coolers 4a and 4b. When the synthesis gas exiting the cooler, cooled to below 500° C. 5, it is ready for the synthesis gas clean-up 6.

This clean-up has the objective to remove, preferably first, any remaining particulates, then tars, acid gases and water. The cleaned synthesis gas, almost free of contamination and on gas turbine feed gas specification 7, is then fed to the gas turbine 8, which drives a generator set 9 to generate the primary power 10. The hot exhaust gases from the combustion chamber of the gas turbine 11 are led to a heat recovery steam generator (HRSG) 12, which purpose is to recover the sensible heat and generate high quality steam 14. The cooled exhaust gases 13 go to the system's stack. The steam 14 serves two purposes: the steam 18b is mixed with steam 18a from the heat generator evaporative cooler 100. The combined steam flow 18 is routed to the synthesis gas coolers 4a and 4b to flow co-currently with the hot raw quality synthesis gas 3 and provide controlled cooling of the metal heat exchange surfaces of the cooler. Advantageously, metal is used instead of ceramic material, which is very preferential cost wise. It becomes possible because of e.g. relatively low temperature differences. It shall be clear to those skilled in the art that, depending on the size of the IGCC, this can happen, also in this embodiment, in one or several stages of which here only two are depicted. The steam becomes superheated in this process. In order to control the temperature and quality of this steam it is led to an attemperator (see details in FIG. 3) to become larger in volume and to become again steam turbine quality 19. Subsequently this steam is fed back to the inlet of the steam turbine 15, which drives a second generator 16 to generate additional power 17.

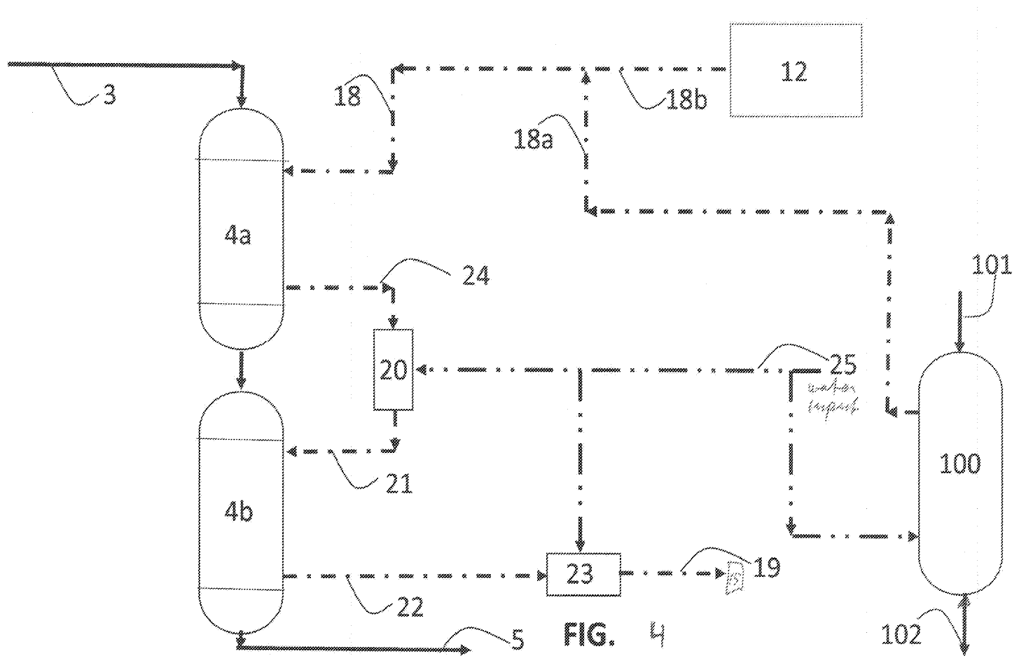

FIG. 4 discloses a detail of FIG. 3. After a gasifier 2 has produce a raw quality synthesis gas 3, which, irrespective of the type of gasifier used, in this process description is expected to have been quenched to or be at about 700-900° C. This synthesis gas is subsequently cooled in synthesis gas cooler 4. The synthesis gas exiting the cooler, is cooled to an exiting gas temperature of below 500° C. 5. For this purpose the raw quality synthesis gas 3 enters the synthesis gas cooler 4a, the first in a series of two. Steam is generated from two sources: hot flue gas (about 900° C.) from the indirect gasifier heat generator 101 enters flue gas cooler 100 to be cooled to about 200° C. 102. This energy is used to convert boiler feed water 25 into saturated steam 18a. This steam flow is mixed with superheated steam 18b from the HRSG 12. The resultant superheated steam flow 18 enters the synthesis gas cooler 4a in co-current flow with the synthesis gas. Having the preferred low steam temperature at this point, this provides for a preferred heat removal capacity at the point of a preferred heat flux, i.e. the synthesis gas cooler inlet. Also this operation is instrumental that the preferred low temperature, which any spot on the metal surface of the synthesis gas cooler ever attains, is the temperature of the inlet steam 18. The latter is controlled by the operating pressure of the HRSG system. At the outlet of synthesis gas cooler 4a the steam 24 is superheated and needs to be corrected in temperature. This is achieved in attemperator 20. In this device the steam exiting the first synthesis gas cooler 4a is intimately mixed with cooler feed water 25 to produce a larger volume superheated steam, with slightly milder temperatures 21, which subsequently is the feed and cooling medium for the second synthesis gas cooler 4b. In this synthesis gas cooling the story around the first synthesis gas cooler 4a repeats itself.

Raw quality synthesis gas exiting the synthesis gas cooler 4a enters synthesis gas cooler 4b, the second in a series of two. Steam flow 21 enters the cooler in parallel flow with the synthesis gas. Having the lowest steam temperature at this point, this provides for the best heat removal capacity at the point of the highest heat flux, i.e. the synthesis gas cooler inlet. This operation is instrumental that the lowest temperature, which any spot on the metal surface of the synthesis gas cooler 4b ever attains, is the temperature of the inlet steam 21. The latter is controlled by the operation of the attemperator 20. At the outlet of synthesis gas cooler 4b the steam is again superheated and needs to be corrected in temperature for use in the steam turbine 15. This is achieved in attemperator 23. In this device the steam exiting the second synthesis gas cooler 4b is intimately mixed with cooler feed water 25 to produce a larger volume superheated steam, with the right steam turbine inlet temperature. 19. The synthesis gas 5, exiting synthesis gas cooler 4b, reaches the desired temperature of below 500° C., though is at a temperature well above the dew point of tars and well above the temperature of deposition of ammonium chlorides.

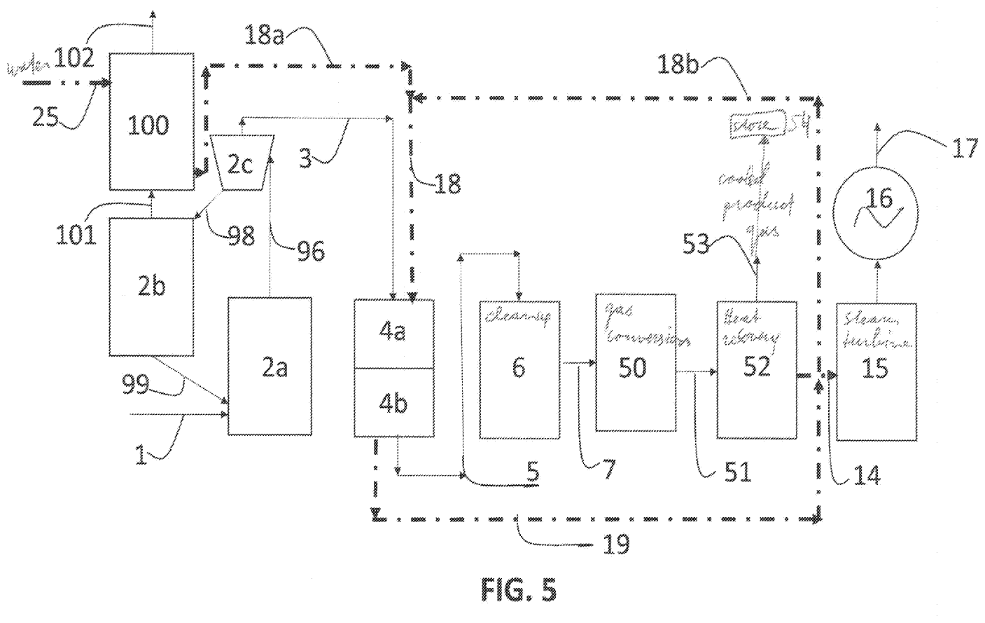

FIG. 5 discloses a hydrocarbon feedstock (coal, petroleum coke, heavy fuel oil, biomass, wood-based materials, agricultural waste, tars, coke oven gas, asphalt or natural gas), and an oxidizer (air, enriched air, oxygen and/or steam) 1 are fed to an indirect gasifier 2 to produce a raw synthesis gas 3. The raw synthesis gas 3 needs, irrespective of the type of gasifier or process used, to be at about 700-900° C. or to be quenched to this temperature. For example the synthesis gas 3 may be generated by a coke oven or steel mill and already be at the 700-900° C. For reasons explained above the hot synthesis gas needs to be cooled further. Therefore this synthesis gas is subsequently cooled in synthesis gas coolers 4a and 4b. The synthesis gas exiting the cooler, cooled to below 500° C. 5, is ready for the synthesis gas clean-up 6. This clean-up has the objective to remove first any remaining particulates, then tars, acid gases and water. The cleaned synthesis gas, free of contamination and on conversion process feed gas specification 7, is then fed to the gas conversion reactor 50. The hot product 51 is led to a heat recovery steam generator 52, which purpose is to recover the sensible heat and generate high quality steam 14. The cooled products 53 go to the system's storage tanks 54. The high quality steam 14 serves two purposes: the high quality superheated steam 18 is routed to the synthesis gas coolers 4a and 4b to flow co-currently with the hot raw quality synthesis gas 3 and provide controlled cooling of the metal heat exchange surfaces of the cooler 4. It shall be clear to those skilled in the art that, depending on the size of the conversion reactor this can happen in one or several stages of which two are depicted. The high quality steam becomes even further superheated in this process. In order to control the temperature and quality of this steam it is led to an attemperator (see details in FIG. 4) to become larger in volume and steam turbine quality again 19. Subsequently this steam is fed back to the inlet of the steam turbine 15, which drives a generator 16 to generate power 17.

As FIG. 5 is a combination of the gasifier of FIG. 3 with the gas conversion and product gas store, also a combination of such gas conversion and product gas store is possible with the direct gasifier of FIG. 1.

As used herein, the term “about”, modifying any amount, refers to the variation in that amount encountered in real world conditions, e.g. in a production facility. The amount is therefore non-binding and only indicative.

As used herein, an element of step recited in the singular and proceeded with the word “a” or “an” should be understood as not excluding plural such said elements or steps, unless such exclusion is explicitly recited. Furthermore, while the invention has been described in terms of various specific embodiments to disclose the invention, those skilled in the art will recognize that the invention can be practiced with modifications within the spirit and scope of the claims. Hence, the existence of additional embodiments that also incorporate the recited features is not to be excluded. Therefore the following claims are in no way intended to limit the scope of the invention to the specific embodiments described herein.

The term Synthesis gas relates to synthetic gas resulting from a gasifying process. The term product gas is used for gas that is used as a product for input in later processes or sales of such gas.

The present invention is described in the foregoing on the basis of several preferred embodiments. Different aspects of different embodiments can be combined, wherein all combinations which can be made by a skilled person on the basis of this document must be included. These preferred embodiments are not limitative for the scope of protection of this document. The rights sought are defined in the appended claims.

The invention claimed is:

1. A method for treating synthesis gas produced from hydrocarbon feedstock from an indirect or direct gasifier, the method comprising steps for:
introducing feedstock and hot bed material into a gasification reactor of an indirect gasifier to produce raw synthesis gas,
introducing the raw synthesis gas and hot bed material from the gasification reactor into a cyclone to separate the hot bed material from the raw synthesis gas,
introducing the separated hot bed material from the cyclone into a heat generator and then into the gasification reactor to supply hot bed material to the gasification reactor,
allowing all of the synthesis gas within a predetermined entry temperature range to flow into a first heat exchanger,
allowing all of the synthesis gas to flow through the first heat exchanger while exchanging heat to a first heat medium,
allowing all of the synthesis gas to transfer from the first heat exchanger to a subsequent last heat exchanger,
allowing all of the synthesis gas to flow though the last heat exchanger while exchanging heat to a last heat medium, and
allowing all of the synthesis gas to exit the last heat exchanger for being available to a further treatment, within a predetermined exit temperature range below an ash or mineral solidification point and above a hydrocarbon liquefying point,
wherein the further treatment is feeding the synthesis gas to a gas turbine which produces exhaust gas and thereafter passing the exhaust gas through a heat recovery steam generator in a process to heat steam to superheated steam and wherein the superheated steam is introduced into a steam turbine for driving the steam turbine.

2. The method according to claim 1, in which each of the first and last heat exchangers operate on steam cooling.

3. The method according to claim 1, in which each of the first and last heat exchangers operate on superheated steam cooling.

4. The method according to claim 1, wherein each of the first and last heat medium is obtained from or pre heated in a flue gas cooler of the gasifier and/or in a heat recovery step relating to the synthesis gas passing through the first or last heat exchanger.

5. The method according to claim 1, in which the predetermined entry temperature range is between 600-1200° C.

6. The method according to claim 1, in which the predetermined exit temperature range is between 400-600° C.

7. The method according to claim 1, wherein the first heat medium and the last heat medium are used to heat steam from the heat recovery steam generator.

8. The method according to claim 1, further comprising the step of adding a coolant to the last heat medium before entering the last heat exchanger to adjust the temperature of the last heat medium.

9. The method according to claim 1, further comprising introducing at least one intermediate heat exchanger between the first and second heat exchangers such that all of the synthesis gas is allowed to flow through the intermediate heat exchanger while exchanging heat to an intermediate heat medium.

10. The method according to claim 1, in which one of the first or last heat exchangers is of the fire tube type.

11. The method according to claim 1, in which one of the first or last heat exchangers is of a water tube type.

12. The method according to claim 1, further comprising a step of cleaning the synthesis gas by removing particulates, tars, acid gases.

13. The method according to claim 1, further comprising a step of feeding the synthesis gas into a gas turbine for driving a generator set.

14. The method according to claim 1, further comprising a step of operating a steam turbine from energy remaining in the heat medium from the last heat exchanger and/or from energy remaining from a heat medium from a heat recovery step.

15. The method according to claim 1, further comprising a step of adjusting an entrance temperature of the last heat medium to the input of the steam turbine.

16. A cooling system for cooling synthesis gas from an indirect or direct gasifier; the system comprising:
a gasification reactor of an indirect gasifier to accept feedstock and hot bed material to produce raw synthesis gas,
a cyclone connected to the gasification reactor to receive and separate the hot bed material from the raw synthesis gas,
a heat generator connected to the cyclone to accept the separated hot bed material, wherein the heat generator is connected to the gasification reactor to supply hot bed material to the gasification reactor,
a first heat exchanger for allowing the synthesis gas to exchange heat to a first heat medium,
a subsequent last heat exchanger for allowing all of the synthesis gas to exchange heat to a last heat medium,
means for allowing all of the synthesis gas to enter the first heat exchanger, and
an exit means for allowing all of the synthesis gas to exit the last heat exchanger within an exit temperature range below an ash or mineral solidification point, further above a hydrocarbon liquefying point for further treatment,
wherein the further treatment is feeding the synthesis gas to a gas turbine which produces exhaust gas and thereafter passing the exhaust gas through a heat recovery steam generator in a process to heat steam to superheated steam and wherein the superheated steam is introduced into a steam turbine for driving the steam turbine.

17. The cooling system according to claim 15, in which the first and last heat exchangers are operable on steam cooling.

18. The cooling system according to claim 15, in which the first and last heat exchangers are operable on superheated steam cooling.

19. The cooling system according to claim 16, further comprising means for adjusting an entrance temperature of the last heat medium.

20. A gasification system for production of synthesis gas comprising a cooling system according to claim 16, and further comprising:
a flue gas cooler comprising means for heating up steam for use in the heat exchangers,
a cleaning system for cleaning synthesis gas after leaving the last heat exchanger by removing particulates, tars, acid gases, and water, and/or,
a gas turbine for driving a generator set,
a heat recovery device, relating to the synthesis gas passing through the first or subsequent heat exchanger.
